(19) United States
(12) Patent Application Publication
(10) Pub. No.: US 2024/0372866 A1
(43) Pub. Date: Nov. 7, 2024

(54) REMOTE OPERATION SYSTEM, IMAGE PROCESSING APPARATUS, REMOTE OPERATION METHOD, AND NON-TRANSITORY RECORDING MEDIUM

(71) Applicant: CANON KABUSHIKI KAISHA, Tokyo (JP)

(72) Inventor: HIROFUMI MOCHIZUKI, Saitama (JP)

(21) Appl. No.: 18/650,986

(22) Filed: Apr. 30, 2024

(30) Foreign Application Priority Data
May 2, 2023 (JP) 2023-076111

(51) Int. Cl. H04L 9/40

(52) U.S. Cl. CPC H04L 63/102; H04L 63/08

(57) ABSTRACT

A remote operation system provided with an image processing apparatus for which physical authentication at the time of a login is set, and a client PC configured to perform remote operations, wherein the remote operation system comprises a request receiving unit configured to receive a remote operation request for the image processing apparatus from the client PC; an account classification determining unit configured to determine whether or not a classification of a user account that is included in the remote operation request is a designated account; and a login authorizing unit configured to authorize the remote operation request when the account classification determining unit has determined that the classification of the account is the designated account.

### BACKGROUND OF THE DISCLOSURE

### Field of the Disclosure

The present disclosure relates to a remote operation system, a remote operation method, and the like that make it possible to log in to an image processing apparatus for which physical authentication at the time of a login has been set using a remote operation.

### Description of the Related Art

The required security level for MFP (multifunction peripheral), which are one type of image processing apparatus, has increased in recent years. In order to log in to an MFP, it is necessary to input a plurality of authentication information, such as multifactor identification or the like.

In addition, the need for remote operations to MFPs in companies and the like that have a plurality of operation bases has also increased in recent years. There are many cases in which such companies or the like in which support staff who respond to issues with the MFPs, such as MFP management engineers or the like, are not available at each operation base. Therefore, when an issue occurs for an MFP that is installed in a remote location, it is necessary for the support staff to collect information related to the issue, and to resolve the issue using remote operations without travelling to the location in which the MFP is installed.

Japanese Unexamined Patent Application, First Publication No. 2022-113037 discloses an image processing apparatus comprises a multi-factor authentication function. When logging in to this image processing apparatus, in the case of local access, physical authentication is performed using an IC card or the like, and in the case of remote access, a onetime password is used.

However, in the technology that has been disclosed in Japanese Unexamined Patent Application, First Publication No. 2022-113037, in a case in which physical authentication with an IC card or the like has been set on the MFP, it is not possible for support staff to log in to the MFP using a remote operation.

Therefore, when the support staff is a performing remote operation to the MFP, solutions such as requesting that a third party who is able to directly operate the MFP perform the login operation using physical authentication in the place of the support staff, or the like are necessary. However, this lowers the security of the MFP despite the MFP having been set to physical authentication.

In addition, although solutions that allow remote operations such as setting a password for each user account, or the like have been thought of, setting these takes time and effort and lacks convenience.

### SUMMARY OF THE DISCLOSURE

The present disclosure makes it such that support staff can use a remote operation to log in to an image processing apparatus for which physical authentication at the time of a login has been set.

In order to solve the above described issue, the remote operation system according to one embodiment of the present disclosure is a remote operation system that comprises an image processing apparatus in which physical authentication at the time of a login has been set, and a client PC configured to remotely operate the image processing apparatus, wherein the remote operation system comprises a request receiving unit configured to receive remote operating requests for the image processing apparatus from the client PC, an account classification determining unit configured to determine whether or not a classification of a user account that is included in the remote operation request is a designated account, and a login authorizing unit configured to authorize the remote operation request when the account classification determining unit has determined that the classification of the user account is the designated account.

Further features of the present disclosure will become apparent from the following description of exemplary embodiments with reference to the attached drawings.

### BRIEF DESCRIPTION OF THE DRAWINGS

FIG. 1 is a diagram showing one example of a configuration of an MFP remote operation system.

FIG. 2 is a diagram showing one example of a hardware configuration of an MFP.

FIG. 3 is a diagram showing one example of a hardware configuration of a client PC and an MFP coordinating service.

FIG. 4 is a diagram showing one example of a software configuration of an MFP remote operation system.

FIG. 5 is a diagram showing a remote login processing sequence in an MFP remote operation system.

FIG. 6 is a flowchart showing the details of processing that is performed by the client PC at the time of a remote login.

FIG. 7 is a flowchart showing the details of processing performed by the MFP at the time of a remote login.

FIG. 8 is a flowchart showing details of processing performed by the MFP coordinating service at the time of a remote login.

### DESCRIPTION OF THE EMBODIMENTS

As an example of an image processing apparatus (image forming apparatus) to which the present disclosure has been applied, a multi-function peripheral (MFP) that has been installed in an office or the like and comprises functions such as copying, printing, scanning, and the like, will be explained.

### [Configuration of the MFP Remote Operation System 100]

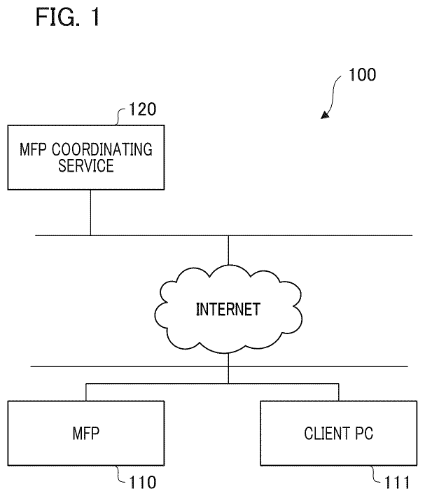

FIG. 1 is a diagram showing the entire configuration of an MFP remote operation system 100.

The MFP remote operation system 100 comprises an MFP 110, a client PC 111, and an MFP coordinating service 120.

The MFP 110 and the client PC 111 are communicably connected to a server (the MFP coordinating service 120 or the like) that provides each type of service via a network such as a LAN (Local Area network), the internet or the like.

The MFP 110 is a multi-function peripheral that has a plurality of functions such as a scanner, a printer, or the like, and is one example of an image processing apparatus (image forming apparatus).

The client PC 111 is a computer (an information processing apparatus) that receives the provision of services that have been requested from the MFP coordinating service 120.

The MFP coordinating service 120 is a server that has the function of remotely operating the MFP 110. The MFP coordinating service 120 provides services that perform login authentication for the MFP 110, save image files that have been scanned within its own server, and transfers image files to storage services and the like.

Normally, the MFP 110 and the MFP coordinating service 120 are in a state in which they are always connected by the internet, and remote login processing and the like for the MFP 110 is performed by communication with the MFP coordinating service 120.

The MFP coordinating service 120 connects to both the MFP 110 and the client PC 111, and relays the transmission and reception of remote operation data and the like. The MFP remote operation system 100 has a configuration that comprises the MFP 110, the client PC 111, and the MFP coordinating service 120. However, it is not limited thereto. For example, the roles of the MFP 110 and the MFP coordinating service 120 may also be provided by the same apparatus.

In addition, this may also be in a state in which the MFP coordinating service is installed on a network such as LAN or the like, and connected thereby, instead of on the internet.

[Hardware configuration of the MFP 110]

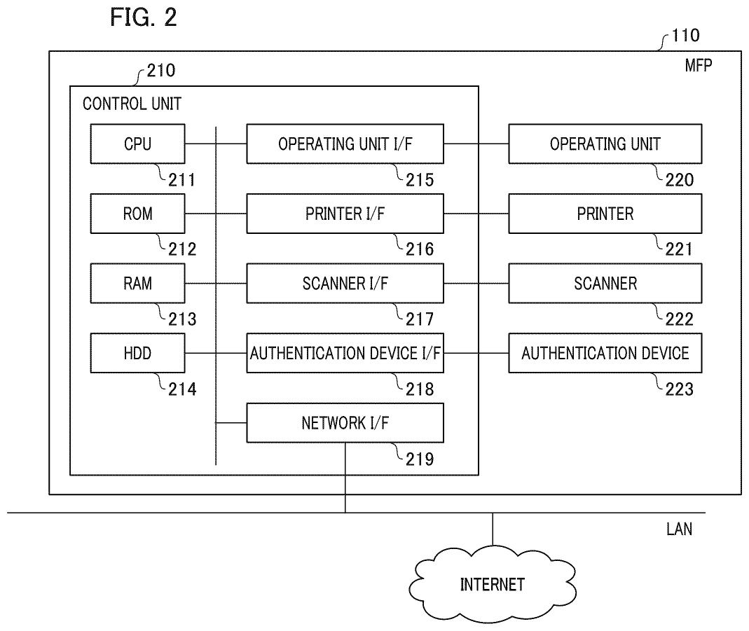

FIG. 2 is a hardware configuration diagram for the MFP 110.

The MFP 110 comprises control unit 210, an operating unit 220, a printer unit 221, a scanner unit 222, an authentication device 223, and the like.

The control unit 210 comprises a CPU 211, a network I/F 219, and the like, and integrally controls the MFP 110.

The CPU 211 reads out a control program that has been stored on a ROM 212, and executes/controls each type of function had by the MFP 110, such as reading, printing, communications, and the like.

A RAM 213 is used as a temporary storage region such as the main memory of the CPU 211, a work area, or the like.

In the present embodiment, although each processing to be described below is executed by one CPU 211 using one memory (the RAM 213, or an HDD 214), the present invention is not limited thereto. For example, each processing may also be executed by making a plurality of CPUs and a plurality of RAMS or HDDs cooperate.

The HDD 214 is a mass storage unit configured to store image data, and each type of program.

An operating unit I/F 215 is an interface configured to connect the operating unit 220 and the control unit 210. The operating unit 220 comprises a touch panel or keyboard, a liquid crystal display unit, and the like, and receives operations/inputs/commands from a user.

A printer I/F 216 is an interface that connects the printer unit 221 and the control unit 210. The printer unit 221 prints image data for printing that has been transmitted from the control unit 210 via the printer I/F 216 onto a storage medium.

A scanner I/F 217 is an interface that connects the scanner unit 222 and the control unit 210. The scanner unit 222 reads an original document that has been set onto a document tray or an ADF (auto document feeder) that is not illustrated, and generates image data, then inputs this to the control unit 210 via the scanner I/F 217.

In addition to print output of image data that has been generated by the scanner unit 222 from the printer unit 221, the control unit 210 is also able to perform file transmission or email transmission of this image data.

An authentication device I/F 218 is an interface that connects the authentication device 223 and the control unit 210. The authentication device (authentication unit) 223 is, for example, a card reader that reads IC cards, a fingerprint authentication device that reads fingerprints, or the like. When a user is using the MFP 110, the authentication device 223 reads information that has been stored on an IC card, or biometric information such as a fingerprint or the like. That is, the authentication device 223 performs physical authentication by IC card authentication or biometric authentication.

The network I/F 219 is an interface that connects the control unit 210 (the MFP 110) to a LAN. The MFP 110 transmits image data and information to each service, and receives each type of information on the internet using the network I/F 219.

[The hardware configuration of the client PC 111 and the MFP coordinating service 120]

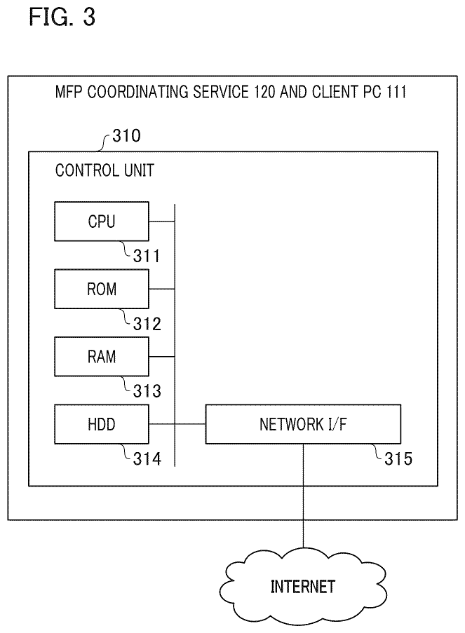

FIG. 3 is a hardware configuration diagram for the client PC 111 and the MFP coordinating service 120. The client PC 111 and the MFP coordinating service 120 comprise the same hardware configurations.

The client PC 111 and the MFP coordinating service 120 are both comprise a control unit 310. The control unit 310 comprises a CPU 311, a ROM 312, a RAM 313, an HDD 314, a network I/F 315, and the like.

The CPU 311 controls the entirety of operations by reading out each type of program (the program of the present disclosure) that has been stored on the ROM 312 and executing each type of processing.

The RAM 313 is used as a temporary storage region such as the main memory of the CPU 311, a work area, or the like.

The HDD 314 is a mass storage unit configured to store image data and each type of program.

The network I/F 315 is an interface that connects the client PC 111 and the MFP coordinating service 120 to the internet. The MFP coordinating service 120 transmits and receives each type of information by receiving processing requests from another apparatus (the MFP 110 or the like) via the network I/F 315.

### [Software (Program) Configuration of the MFP Remote Operation System 100]

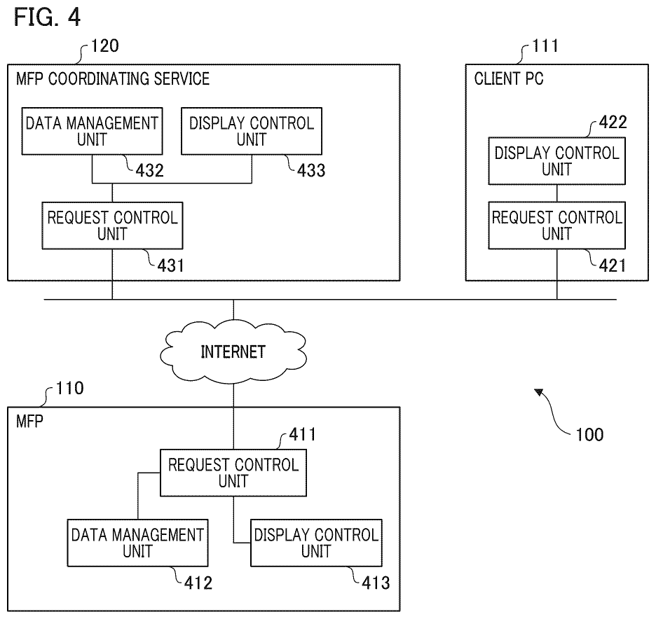

FIG. 4 is a software configuration diagram for the MFP remote operation system 100.

The MFP 110 comprises a request control unit 411, a data management unit 412, a display control unit 413, and the like.

The request control unit 411 stands by in a state in which it is able to receive a request from the MFP coordinating service 120. Upon receiving a processing request, the request control unit 411 performs a processing command to the display control unit 413, and to the data management unit 412 appropriately in response to the request. The request control unit 411 functions as the request receiving unit, the account classification determining unit, and the login authorizing unit of the present disclosure.

The data management unit 412 stores and manages user information (user account information and the like), the settings for the MFP coordinating service 120, and the like.

The display control unit 413 displays a UI screen for receiving operations from a user on a liquid crystal display unit of the operating unit 220 of the MFP 110. The display control unit 413 displays, for example, the login method for the MFP 102, and displays a UI screen for inputting authentication information for accessing the MFP coordinating service 120, and the like.

The display control unit 413 receives a command for a remote operation from the request control unit 411 and is controlled. In addition, the display control unit 413 transmits screen information for the display operating unit to the MFP coordinating service 120 via the request control unit 411.

The client PC 111 comprises a request control unit 421, a display control unit 422, and the like.

The client PC 111 accesses the MFP coordinating service 120, which has been connected through the internet or through a LAN, via the request control unit 421.

The user confirms user information that is registered on the MFP coordinating service 120 from a screen that has been displayed by the display control unit 422 of the client PC 111, and performs remote operations to the MFP 110 that has been connected to the MFP coordinating service 120.

The MFP coordinating service 120 comprises a request control unit 431, a data management unit 432, a display control unit 433, and the like.

The request control unit 431 stands by in a state in which it can receive a request from the MFP 110. The request control unit 431 may also be made to function as the account classification determining unit of the present invention instead of the request control unit 411 or in addition to the request control unit 411.

The data management unit 432 has information such as user information for authenticating the MFP coordinating service 120 and the MFP 110, each type of settings for the MFP coordinating service 120, the MFPs 110 that the MFP coordinating service 120 is managing, and the like.

User information comprises information relating to a user classification, settings values, and logins. As the user classification, there are managers who are able to access all of the functions, general users who have been set so as not to be able to access a portion of the functions, users who are in charge of service maintenance, or external servicemen, and the like. Users who are in charge of maintenance, external servicemen, and the like are given support accounts as their user accounts. A support account is indicated as a designated account that will be described below.

The information such as the MFP 110 and the like comprises the device name, IP address, serial number, status of the MFP 110 or the like, and the like.

The display control unit 433 receives requests from the client PC 111 and the like that has been connected via the internet, and returns screen configuration information necessary to display a screen (HTML, CSS, and the like), and information for remote operations of the MFPs 110.

In the present embodiment, although there is only one each of the client PC 111 and the MFP 110 that are connected to the MFP coordinating service 120, the present invention is not limited thereto. A plurality of client PCs and MFPs may also be connected to the MFP coordinating service 120.

### [Remote Login Processing Method (Remote Operation Method)]

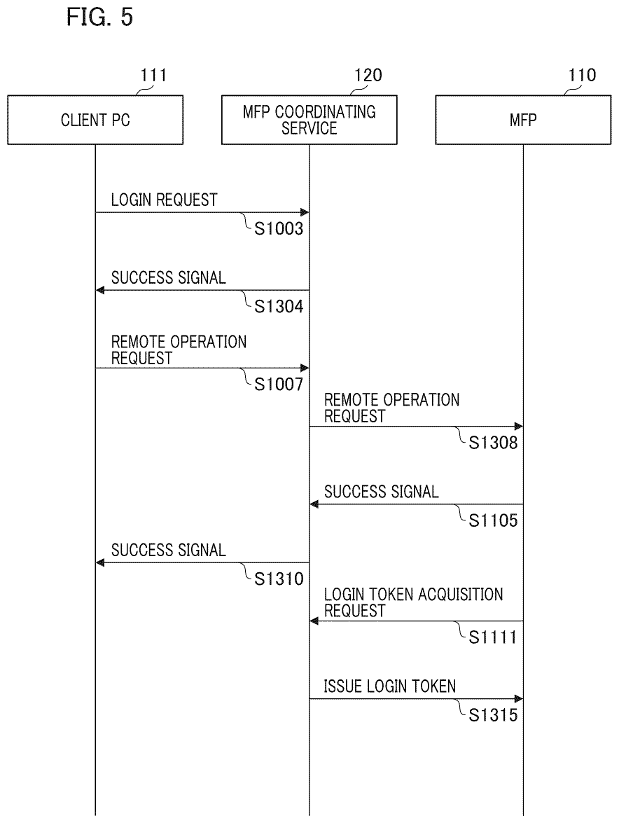

FIG. 5 is a diagram showing a processing sequence for a remote login in the MFP remote operation system 100. In FIG. 5, a sequence is shown for when a remote login to the MFP 110 from the client PC 111 has succeeded.

The client PC 111 transmits a login request to the MFP coordinating service 120 (S1003).

The MFP coordinating service 120 verifies user information that is included in the login request that has been received (S1303), and transmits a success signal for the login request to the client PC 111 (S1304).

The client PC 111 receives the success signal for the login request (S1004), and transmits a remote operation request for the MFP 110 (including the user account) to the MFP coordinating service 120 (S1007).

The MFP coordinating service 120 receives the remote operation request for the MFP 110 from the client PC 111 (S1307), and transmits a remote operation request to the MFP 110 (S1308).

The MFP 110 receives the remote operation request from the MFP coordinating service 120 (S1101: request receiving process). In addition, it is determined whether or not the user account that is included in the remote operation request is a designated account (for example, a support account) (S1103: account classification determining process).

The MFP 110 authorizes the remote operation request only in a case in which the user account is a designated account. Specifically, the MFP 110 transmits the success signal for the remote operation request to the MFP coordinating service 120 (S1105: login authorizing process). In addition, the MFP 110 begins transmission and reception of remote operating data with the MFP coordinating service 120 (S1106).

Upon the remote operation request succeeding (S1309), the MFP coordinating service 120 transmits a remote operation request success signal to the client PC 111 (S1310). The MFP coordinating service 120 then begins the transmission and reception of remote operation data with the MFP 110 and the client PC 111 (S1312).

Upon the remote operation request succeeding, the client PC 111 starts the transmission and reception of remote operations with the MFP coordinating service 120 (S1009).

The MFP 110 transmits an MFP login token acquisition request to the MFP coordinating service 120 (S1111).

The MFP coordinating service 120 receives the MFP login token acquisition request (S1313). The MFP coordinating service 120 issues an MFP login token, and transmits this to the MFP 110 (S1315).

Upon receiving the MFP login token (S1112), the MFP 110 performs remote login processing after having verified the MFP login token (S1113).

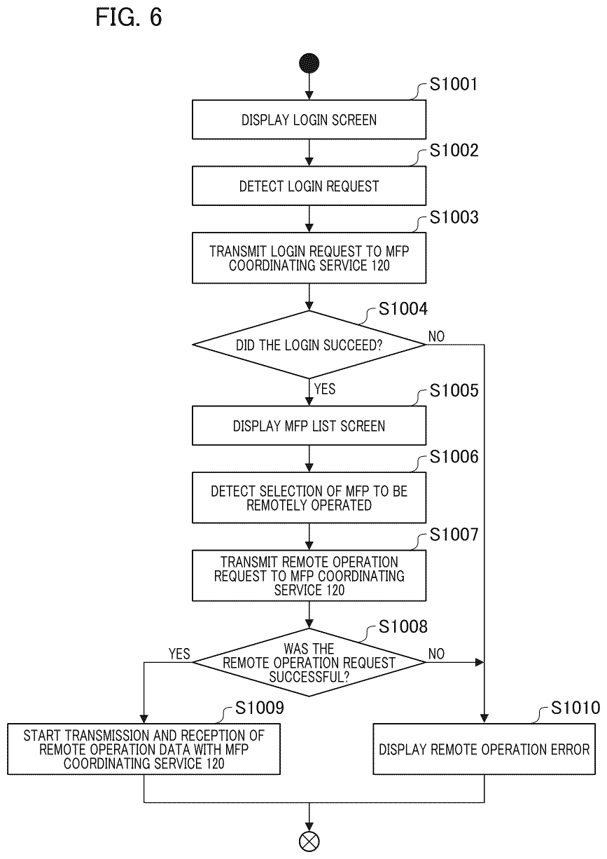

FIG. 6 is a flowchart showing the details of the processing performed by the client PC 111 at the time of remote login processing.

The client PC 111 opens a browser, and displays a login screen that has been received from the MFP coordinating service 120 (S1001).

The client PC 111 detects that a user has input login information and performed a login request (S1002). This login information is, for example, a username (a user account), and a password.

The client PC 111 transmits a login request to the MFP coordinating service 120 (S1003).

The client PC 111 receives the results of the login request that was transmitted during S1003, and confirms if the login request succeeded (S1004).

In a case in which the login request has not succeeded, an error signal is output, and the processing is completed (S1010). In contrast, in a case in which the login request has succeeded, the client PC 111 receives and displays a list screen of MFPs that are managed by the MFP coordinating service 120 (S1005).

This list information includes an MFP identifier that uniquely specifies an MFP. The client PC 111 detects that an MFP that is the target of the remote operation has been selected from the list screen (S1006).

The MFPs that can be selected at this time may be limited to only the MFPs to which connection is possible. For example, MFPs that are registered in the MFP coordinating service 120 but are not in a state in which they are connected to the network or for which the remote operation settings are not valid cannot be selected. In addition, it may also be made such that an MFP that is currently being remotely operated by another user cannot be selected.

The client PC 111 transmits a remote operation request for the MFP that has been selected to the MFP coordinating service 120 (S1007).

The client PC 111 confirms whether or not the remote operation that was received from the MFP coordinating service 120 was successful (a success signal or a failure signal) (S1008).

In a case in which the remote operation request failed, the client PC 111 displays a remote operation error, and the processing is completed (S1010). In contrast, in a case in which the remote operation request was successful, the client PC 111 begins the transmission and reception of remote operations with the MFP coordinating service 120 (S1009), and the present processing is completed.

Note that the data that is transmitted and received during the processing S1009 is, for example data in which the communications of a VNC server that operates on the MFP 110, which is the target of the remote operation, has been received has been wrapped using HTTP communications with the MFP coordinating service 120. These communications are received by the client PC 111 via the MFP coordinating service 120. The client PC 111 displays VNC data that was received using a browser, a VNC client, or the like, and performs operations.

In the same manner, the client PC 111 transmits remote operation data to the MFP 110 via the MFP coordinating service 120, and the MFP 110 is operated based on the remote operations data that has been received. It is thereby possible for the client PC 111 to perform remote operations to the MFP 110 via the MFP coordinating service 120.

Note that although in this context, an example has been given in which the VNC is wrapped using HTTP communications, it is sufficient if this is data that is able to remotely operate the MFP 110.

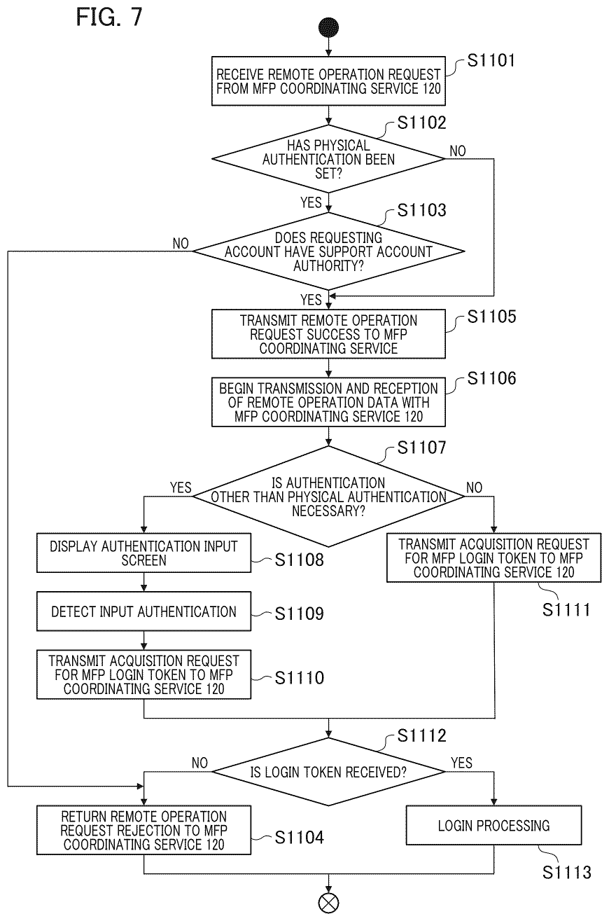

FIG. 7 is a flowchart showing the details of the processing that is performed by the MFP 110 at the time of remote login processing.

The MFP 110 receives a remote operation request from the MFP coordinating service 120 (S1101: request reception process). This communication includes a user account for the user that transmitted the remote operation request.

The MFP 110 confirms whether or not the authentication method that is set as the login unit in the MFP 110 is physical authentication (S1102). Physical authentication is an authentication unit that authenticates a login based on weather information that was read by the authentication device 223 matches information that is included in user data for use in logins that is stored on the data management unit 412 of the MFP 110.

In a case in which physical authentication has not been set, the MFP 110 performs the processing S1105 and S1106, which will be explained below. In contrast, in a case in which physical authentication has been set, the MFP 110 confirms weather the account that has requested remote operation is a designated account (S1103: account classification identifying process).

Note that as the designated account, for example, a support account has been set in advance.

In a case in which the account that has requested remote operations is not a designated account (that is, a support account), the MFP 110 transmits a rejection for the remote operation request (a failure signal) to the MFP coordinating service 120, and the processing is completed (S1104).

In contrast, in a case in which the account that has requested remote operation is a support account, the MFP 110 transmits a success signal for the remote operation request to the MFP coordinating service 120 (S1105: login authorizing process). That is, the remote operation request is authorized without performing physical authentication using the authentication device 223.

Furthermore, the MFP 110 begins the transmission and reception of remote operation data with the MFP coordinating service 120 (S1106). That is, in a case in which physical authentication has been set, it is set such that remote operations will become possible only in a case in which the user classification (the user account) is a support account.

In addition, the MFP 110 transmits screen data for the MFP 110 to the client PC 111 via the MFP coordinating service 120, and receives remote operation data from the client PC 111 via the MFP coordinating service 120. The MFP 110 is operated based on the remote operation data that has been received.

Note that although the MFP 110 has confirmed the account classification, the MFP coordinating service 120 may also confirm the account classification. That is, the MFP coordinating service 120 (the request control unit 431) is made to function as the account classification determining unit of the present invention. In this case, the MFP coordinating service 120 performs the processing S1103, and transmits the information that shows whether or not this is a designated account to the MFP 110.

The MFP 110 confirms whether or not authentication other than physical authentication has been set in the MFP 110 (S1107). Specifically, the input of a pin or a password.

In a case in which authentication other than physical authentication has been set, the MFP 110 transmits an acquisition request for an MFP login token to the MFP coordinating service 120 (S1111). At this time, in order to identify the user that is performing the login, the user account that was received during the processing S1001 is also transmitted at the same time.

In a case in which authentication other than physical authentication has been set, the MFP 110 displays an authentication input screen (S1108). This screen is also displayed on the client PC 111 that is performing the remote operations, and it is possible to perform the input from the client PC 111.

The MFP 110 detects an authentication input by remote operation from the client PC 111 (S1109), and transmits an acquisition request for an MFP login token to the MFP coordinating service 120 (S1111). At this time, the user account that was received during S1101, and the authentication information that was acquired during 1109 are transmitted at the same time to the MFP coordinating service 120.

The MFP 110 confirms if the MFP login token has been received from the MFP coordinating service 120 (S1112).

In a case in which an MFP login token has not been received, this is made an error, a remote operation request rejection is transmitted to the MFP coordinating service 120, and the processing is completed (S1104). In contrast, in a case in which an MFP login token has been received, the MFP 110 verifies the MFP login token that was received, and performs remote login processing (S1113).

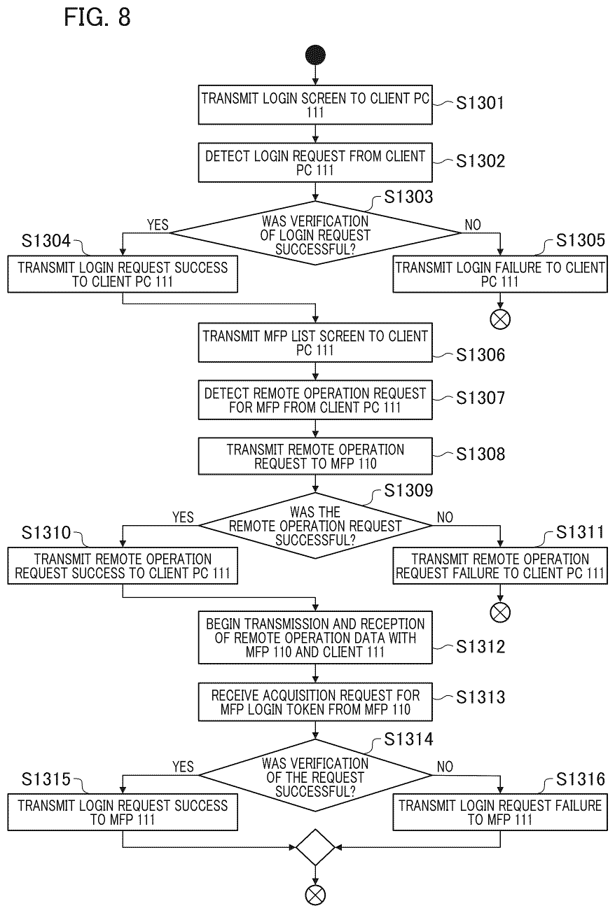

FIG. 8 is a flowchart showing the details of the processing performed by the MFP coordinating service 120 at the time of remote login processing.

The MFP coordinating service 120 transmits a login screen to the client PC 111 (S1301). The MFP coordinating service 120 detects a login request from the client PC 111 (S1302).

The MFP coordinating service 120 verifies the user information that is included in the login request that has been received by using the user information that is managed by the MFP coordinating service 120 (S1303).

In a case in which the verification of the user information has failed, a failure signal for the login is transmitted to the client PC 111 and the processing is completed (S1303). In contrast, in a case in which the verification of the user information was successful, the MFP coordinating service 120 transmits a login success signal to the client PC 111 (S1304)

The MFP coordinating service 120 transmits a screen with a list of the MFPs managed by the MFP coordinating service 120 to the PC 111 (1306).

The MFP coordinating service 120 receives a remote operation request for an MFP from the client PC 111 (S1307). The MFP coordinating service 120 specifies the MFP 110 from the MFP identifier that is included in the request, and transmits the remote operation request to the MFP 110 (S1308).

The MFP coordinating service 120 confirms whether or not the remote operation request from the MFP 110 was successful (a success signal, a failure signal) (S1309).

In a case in which the remote operation request failed, a failure signal for the remote operation request is transmitted to the client PC 111, and the processing is completed (S1311). In contrast, in a case in which the remote processing request succeeded, a success signal for the remote operation request is transmitted to the client PC 111 (S1310).

The MFP coordinating service 120 begins the transmission and reception of remote operation data with the MFP 110 and the client PC 111 (S1312).

After this, the MFP coordinating service 120 transmits remote operation data to the client PC 111 every time that it receives this data from the MFP 110. In addition, the MFP coordinating service 120 transmits remote operation data to the MFP 110 every time that it receives this data from the client PC 111.

The MFP coordinating service 120 receives an acquisition request for an MFP login token from the MFP 110 (S1313)

The MFP coordinating service 120 verifies the information that is included in the acquisition request for the token that was received, and confirms whether or not the acquisition request for the token was successful (a success signal, or a failure signal) (S1314).

In a case in which the acquisition request for the token has succeeded, the MFP coordinating service 120 issues an MFP login token to serve as the login request success signal and transmits this to the MFP 110 (S1315). In contrast, in a case in which the acquisition request for the token failed, the MFP coordinating service 120 transmits a failure signal for the login request (S1316).

As was explained above, according to the present embodiment, it is possible to remotely log in to the MFP 110 without greatly decreasing the security and convenience even in an MFP 110 for which physical authentication at the time of a login has been set. In addition, it is possible to execute each type of remote operation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-076111, filed May 2, 2023, which is hereby incorporated by reference herein in its entirety.

What is claimed is:

1. A remote operation system provided with an image processing apparatus for which physical authentication at the time of a login is set, and a client PC configured to remotely operate the image processing apparatus, the remote operation system comprising:
a request receiving unit configured to receive a remote operation request for the image processing apparatus from the client PC;
an account classification determining unit configured to determine whether or not a classification of a user account that is included in the remote operation request is a designated account; and
a login authorizing unit configured to authorize the remote operation request when the account classification determining unit has determined that the classification of the user account is the designated account.

2. The remote operation system according to claim 1, wherein
the designated account is a support account that has been assigned to a user who is in charge of maintenance for the image processing apparatus.

3. The remote operation system according to claim 1, wherein
the remote operation system is further comprising a coordinating service that connects to both the image processing apparatus and the client PC, and relays the transmission and reception of remote operations data; and wherein
the coordinating service comprises the account classification determining unit.

4. The remote operation system according to claim 1, wherein
the physical authentication is IC card authentication or biometric authentication.

5. An image processing apparatus comprising:
at least one processor; and
at least one memory storing a program that makes the processor function as:
an authentication unit configured to perform physical authentication at the time of a login;
a request receiving unit configured to receive a remote operation request via a network;
an account classification determining unit configured to determine whether or not a classification of a user account that is included in the remote operation request is a designated account; and
a login authorizing unit configured to authorize the remote operation request without physical authentication being performed by the authentication unit when the account classification determining unit has determined that the classification of the user account is the designated account.

6. A remote operation method for an image processing apparatus for which physical authentication at the time of a login is set, wherein the remote operation method comprises:
receiving a remote operation request for the image processing apparatus from a client PC;
determining whether or not a classification of a user account that is included in the remote operation request is a designated account; and
authorizing the remote operation request when the account classification determining unit has determined that the classification of the user account is the designated account.

7. A non-transitory recording medium storing a program of a remote operation method causing a CPU of an image processing apparatus that performs physical authentication at the time of a login by using an authentication unit to perform each step of a method of the remote operation method, the method comprising:
an account classification determining unit configured to determine whether or not a classification of a user account that is included in the remote operation request that has been received via a network is a designated account; and
a login authorizing unit configured to authorize the remote operation request without physical authentication being performed by the authentication unit when the account classification determining unit has determined that the classification of the user account is the designated account.
